(19) United States
(12) Patent Application Publication
(10) Pub. No.: US 2025/0371628 A1
(43) Pub. Date: Dec. 4, 2025

(54) MY OPEN GUILD

(71) Applicant: Rouben Sagatelov, Highland Heights, OH (US)

(72) Inventor: Rouben Sagatelov, Highland Heights, OH (US)

(21) Appl. No.: 19/220,151

(22) Filed: May 28, 2025

Related U.S. Application Data
(60) Provisional application No. 63/653,941, filed on May 30, 2024.

(51) Int. Cl. G06Q 50/00

(52) U.S. Cl. CPC G06Q 50/01

(57) ABSTRACT

According to an aspect of the present invention, there is provided a computer-implemented method for operating a relationship-based network, comprising: receiving a connection request from a user; adding another user to the user's defined relationship-based network based on an indication of an acceptance by the other user; displaying existing connections, dynamically updated new connections, and categories for a user's connections using tags or labels; displaying full profiles for one or more first-degree connections directly connected users sent connection requests to which have been have accepted; display partial profile information for second-degree connections which are the clients or vendors of the user's first degree connections; and displaying limited profile information for third-degree connections which are the connections of the user's second-degree connections.

### BACKGROUND

A number of prior art patent disclosures relate to algorithms for facilitating relationship based connections between businesses.

For example, U.S. Pat. No. 7,426,472 discloses a method and system for linking businesses through common interests. More specifically, the invention can facilitate business relationships by storing business profiles of various participating businesses within a business registry. Participating businesses can query the business registry for other businesses whose business profiles include particular, desirable business attributes. The business profiles can include a variety of business attributes detailing information about the participating businesses. Moreover, the business attributes can include information which can be used to establish a communications link between inquiring businesses and businesses located by a search of the business registry, which can be referred to as “found” or “located” businesses. In this manner, the present invention can effectively link participating businesses through different communications systems. One aspect of the invention includes a method of connecting businesses through common interests. The method can include storing business profiles including business attributes in an online business registry. For example, the business attributes can include business identity information, business description information, and communication information. The storing step further can include defining access rights to the business profiles, defining permissible communications links and points of contact as business attributes within the business profiles, and defining selected business attributes of the business profiles as private. Responsive to a query from an inquiring business, the online business registry can be searched to locate at least one business having a business profile including at least one business attribute corresponding to the query. In one embodiment of the invention, the queried business attributes can be limited to attributes which are common to the inquiring business. At least one communications link can be established between the inquiring business and the located business according to at least one business attribute of the business profile of the located business. For example, communications information for the located business can be extracted from the business profile of the located business and can be used to establish the communications link. Notably, the inquiring business can be authenticated when the communications link is established to ensure security. Another aspect of the invention includes storing business profiles including business attributes in an online business registry, and responsive to a query from an inquiring business specifying at least one business attribute, locating within the online business registry business profiles corresponding to the specified business attribute. For example, the specified business attribute can include a business name or identity. Within the located business profiles, references to other business profiles within the online business registry can be identified. If the other business profiles include business attributes corresponding to the query, a communications link can be established between the inquiring business and at least one of the other businesses having a business attribute corresponding to the query.

However, prior art matching algorithms for connecting businesses, filters, and recommendations are often inefficient, inaccurate and inappropriate.

### SUMMARY OF INVENTION

Therefore, the present invention provides for improved matching algorithms, filters, and recommendations for connecting businesses including for example suppliers and customers.

User-defined rules and user relationships play a crucial role in facilitating meaningful connections and interactions between businesses in the present invention. Relationship-based connectivity matching algorithms are employed to pair businesses based on various criteria such being a vendor or client to parent company. To build “my guild” for a user, the platform accurately matches businesses with compatible partners and therefore the platform enhances the likelihood of productive collaborations and partnerships.

According to an aspect of the present invention, there is provided a computer-implemented method for operating a relationship-based network, comprising: receiving a connection request from a user; adding another user to the user's defined relationship-based network based on an indication of an acceptance by the other user; displaying existing connections, dynamically updated new connections, and categories for a user's connections using tags or labels; displaying full profiles for one or more first-degree connections directly connected users sent connection requests to which have been have accepted; display partial profile information for second-degree connections which are the clients or vendors of the user's first degree connections; and displaying limited profile information for third-degree connections which are the connections of the user's second-degree connections.

### BRIEF DESCRIPTION OF THE DRAWINGS

FIG. 1 illustrates connections according to an embodiment of the present invention.

FIG. 2 illustrates notation according to an embodiment of the present invention.

FIG. 3 illustrates mutual connections at each level according to an embodiment of the present invention.

FIG. 4 illustrates affinity engine features according to an embodiment of the present invention.

FIG. 5 illustrates a mutual affinity score according to an embodiment of the present invention.

FIG. 6 illustrates examples according to an embodiment of the present invention.

### DETAILED DESCRIPTION

The user defined relationship-based connectivity algorithm is a tool used in myopenguild.com website to facilitate meaningful connections and interactions between businesses. It employs matching algorithm, recommendation systems, and connection rules to pair businesses based on mutually acceptance criteria between parent company and its clients and vendors. By analysing profile information, preferences, and historical interactions, the algorithm suggests industry relevant connections and recommendations based on sales size, enhancing the likelihood of productive collaborations and partnerships. Additionally, the algorithm incorporates trust and verification mechanisms to validate the authenticity of businesses and establish trust within the network.

The user defined relationship-based connectivity algorithm solves the problem of inefficiency and lack of relevance in business networking by streamlining the process of identifying and connecting with suitable partners. It addresses the challenge of navigating vast networks of businesses to find the right collaborators or opportunities by leveraging relationship-based algorithms to suggest relevant connections based on specific criteria. This helps businesses overcome the barriers of time and resource constraints associated with traditional networking methods, leading to more efficient and productive interactions. Additionally, the algorithm enhances the quality and reliability of connections by incorporating trust and verification mechanisms, mitigating the risk of engaging with unverified or unreliable partners.

Aspects of the present invention include:
Recommendation Systems: Recommendation systems utilize algorithm to provide personalized recommendations for businesses, content, events, or opportunities based on their interests, behavior, and past interactions on the platform.
Connection Rules and Filters: The platform may implement connection rules and filters to govern the initiation and acceptance of connections between businesses. These rules define criteria such as mutual interests, compatibility, or relevance, which businesses must meet before establishing connectivity algorithm a connection. By enforcing these rules, the platform ensures that connections are meaningful, valuable, and aligned with the user's networking goals.
Trust and Verification Mechanisms: To enhance trust and credibility within the network, the platform may incorporate verification mechanisms and trust signals to validate the authenticity and reliability of businesses. By establishing trust between network participants, the platform fosters a conducive environment for collaboration, transactions, and knowledge sharing.
Network Dynamics and Clustering: user defined relationship-based connection algorithms may also consider network dynamics and clustering patterns to identify communities, clusters, or affinity groups within the network. By analyzing the structure of the network and detecting communities of businesses with shared interests or characteristics, the platform can facilitate targeted networking opportunities, discussions, or events tailored to specific niches or segments within the B2B ecosystem.

User defined and formed relationship-based connections are a fundamental and allowing users to connect with other user defined relationship-based network or users, build their network, and establish professional relationships at www.myopenguild.com. When user send a connection request to someone and they accept it, user become connected on the relationship-based network. For users who have opted into connecting with others have one parent user, one confirmed client and one confirmed vendor, so algorithm can match individuals based on shared clients or vendor's profile. The algorithm identifies segments of Client/Vendor that are shared between users. Once the Clients/Vendors are identified, confirmed and verified, users can choose to share messages or communicate with each other through the platform. This allows global relationship-based network to potentially discover and connect with business partners they were previously unaware of, expanding their understanding business connections.

Here's a detailed explanation of how connections work:
1. Sending Connection Requests: To connect with someone on user defined relationship-based network, user can send them a connection request—Client or Vendor at www.myopenguild.com. This is typically done by using “Add Client” or “Add Vendor” and clicking on the “Add . . . ” button. www.myopenguild.com platform encourages users to connect primarily with working clients and vendors they know professionally, as the platform aims to foster meaningful professional connections.
2. Accepting or Rejecting Connection Requests: When user receive a connection request from another platform user, they have the option to accept or reject it. If user accept the request, they become connected with that www.myopenguild.com, and they become part of their www.myopenguild.com user defined relationship-based network. If user reject the request, the user will not become your connection, but they can still send you messages if user registered on www.myopenguild.com platform.
3. Managing Connections: www.myopenguild.com platform allows users to view their connections including first-degree connections, second-degree connections and third-degree connections+through the “My Network” section. Here, user can view existing connections, dynamically updated new connections, and categorize your connections using tags or labels. This feature helps you organize/categorize your network and stay connected with the members of mutual interests.
4. Network Visibility: Your www.myopenguild.com “My Network” connections can see your profile updates or posts you share on the platform (unless you've adjusted your privacy settings). Likewise, you can see updates from your connections on your www.myopenguild.com feed—“My wall”, “My Events”, “My Reviews”, “My Mail”, etc. Building a larger network of connections expands your reach and potential visibility among other users in your industry or field of interest.
5. Networking Opportunities: www.myopenguild.com connections open up networking opportunities for business. Your connections can introduce you to their connections, providing potential access to new business opportunities, partnerships, collaborations, or industry insights. You can also use your connections to request referrals or recommendations for services or professional advice.
6. first-degree connections, second-degree connections and third-degree connections: www.myopenguild.com also allows you to see the connections of your connections. These business entities are referred to as first-degree connections or second-degree connections or third-degree+connections. While you may not have a direct connection with them, you can reach out to them through your shared connection, enabling you to expand your network further.
7. Membership level Settings: www.myopenguild.com provides 4 levels of membership to control the visibility and accessibility of your connections. You can choose to make your connections visible or entirely private by choosing level of paid membership accordingly. It's important to use www.myopenguild.com connections thoughtfully and purposefully, focusing on building meaningful professional relationships and engaging with your network.

Embodiments of the present invention will be described with reference to the attached drawings.

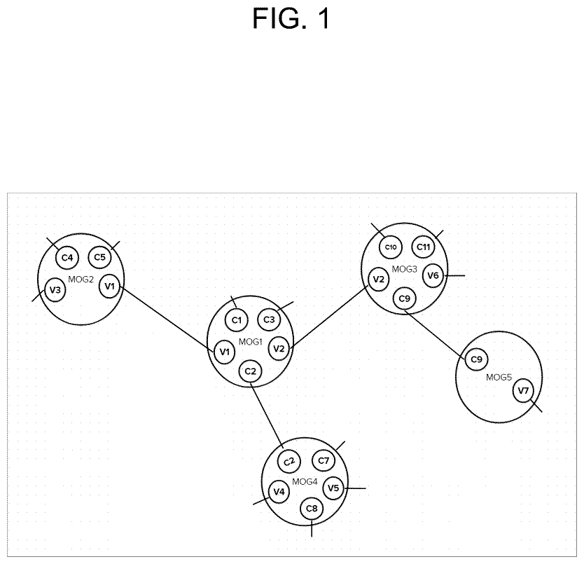

FIG. 1 illustrates connections according to an embodiment of the present invention.

www.myopenguild.com connections can be categorized into three levels: first-degree, second-degree, and third-degree+connections. These levels indicate the proximity of your relationship with other WWW.MYOPENGUILD.COM users. Here's an explanation of each level:
1. First-Degree Connections: First-degree connections are the users you are directly connected with on WWW.MYOPENGUILD.COM. These are the users you have sent connection requests to, and they have accepted. You can view their full profiles, message them directly, see their updates, and engage with their content. Your first-degree connections are considered your primary network on WWW.MYOPENGUILD.COM.
2. Second-Degree Connections: Second-degree connections are the connections of your first-degree connections. In other words, they are the clients or vendors your connections are connected with, but you haven't directly connected with them. While you can't see their full profiles, you can view limited profile information such as number of second-degree connections available but not their name and the number of shared connections. You can also request to connect with them by sending a personalized invitation through a shared connection.
3. Third-Degree Connections: Third-degree connections are the connections of your second-degree connections. They are one level further away from your immediate network. You still can see even more limited profile information compared to second-degree connections.

The concept of degrees of connections allows you to expand your network beyond your direct connections. It provides opportunities to connect with professionals who may share common interests, work in related industries, or have valuable insights. The larger your network becomes, the more second-degree and third-degree connections you'll have, expanding your reach and potential networking opportunities.

WWW.MYOPENGUILD.COM leverages the degrees of connections to facilitate introductions and networking. For example, if you are interested in connecting with a specific business or user who is a second-degree connection, you can use one of your first-degree connections to connect by sending invitations. Similarly, your second-degree connections can request to be connected to you're first-degree connections

WWW.MYOPENGUILD.COM's degrees of connections represent the relationships between users on the platform. Each user is represented as a node, and connections between users are represented as edges. The degrees of connections refer to the distance or number of hops between two users in this graph.

Here's how the concept of degrees of connections works:
1. Building: WWW.MYOPENGUILD.COM maintains user connections, where each user is a node, and connections are the edges between them. When a user sends a connection request and it gets accepted, a new edge is added to the user, linking the two users.
2. First-Degree Connections: First-degree connections are the users directly connected to a particular user. In terms of the unit, they are the immediate neighbors of a specific node. To determine first-degree connections, WWW.MYOPENGUILD.COM platform queries the database for all the edges connected to a user's node.
3. Second-Degree Connections: Second-degree connections are the users who are not directly connected to a particular user but are connected through one mutual connection (first-degree connection). To find second-degree connections, WWW.MYOPENGUILD.COM performs a search starting from a user's node, exploring the edges and nodes connected to their first-degree connections.
4. Third-Degree Connections+: Third-degree connections are the users who are connected to a particular user through two mutual connections (first- and second-degree connections). WWW.MYOPENGUILD.COM performs a similar search, starting from a user's node, but this time it explores the edges and nodes connected to their second-degree connections.

Connectivity above and beyond 3rd level in MyOpenGuild.com technically includes the 4th, 5th, 6th degree, and so on—but the platform intentionally limits direct visibility and interaction due to complex visuals. So, 3rd plus connections combined into one group—3rd plus

WHAT IS “BEYOND 3RD LEVEL” ?(4th, 5th, nth)

In graph terms:
1 st-degree=depth 1
2nd-degree=depth 2
3rd-degree=depth 3

Beyond=depth≥4 (4th, 5th, 6th . . . )

### Problem Definition

We model the network as an undirected graph:

Each user is a node.

A connection (friendship/business relationship) is an edge.

A mutual connection is someone who appears in the intersection of your connection set and someone else's.

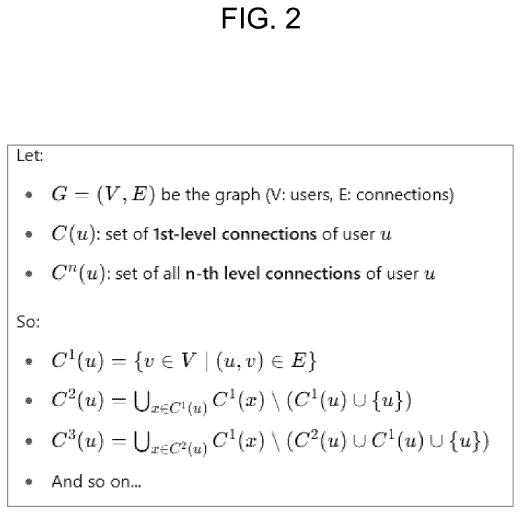

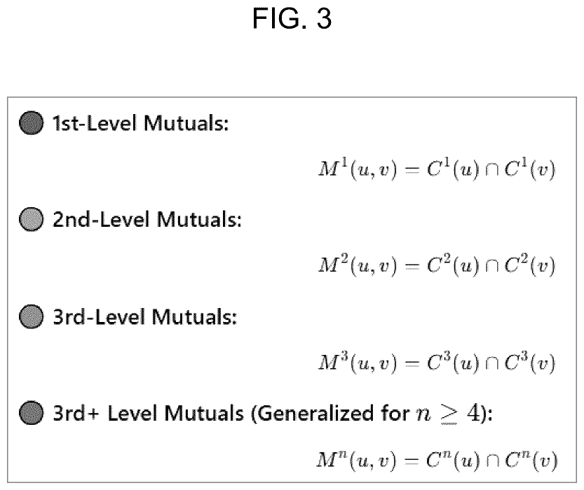

FIG. 2 illustrates notation according to an embodiment of the present invention, and FIG. 3 illustrates mutual connections at each level according to an embodiment of the present invention.

Given two users u and v, their mutuals at each level are:

Each of these sets represents people who are in both users' networks at the same depth level.

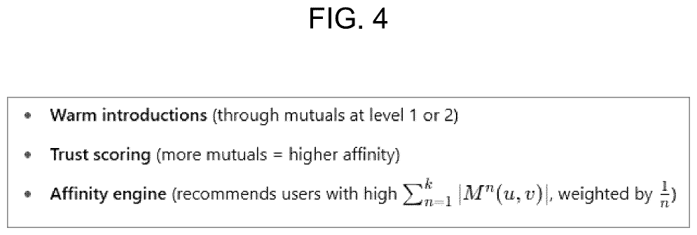

FIG. 4 illustrates affinity engine features according to an embodiment of the present invention.

### Why This Matters in MyOpenGuild

This model powers features like:
Total Mutual Affinity Score (Optional Formula)

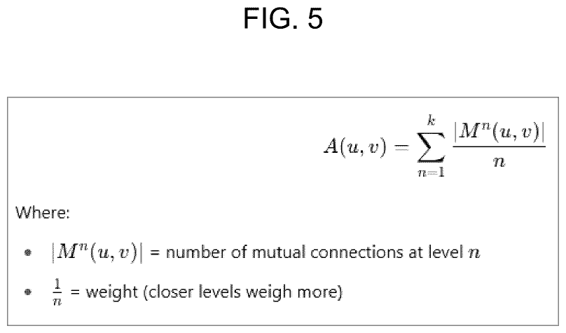

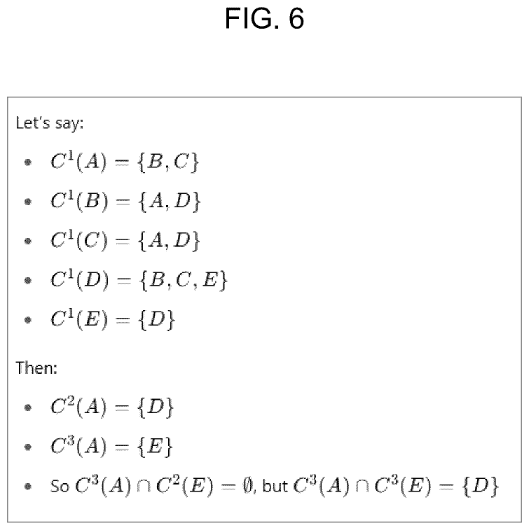

FIG. 5 illustrates a mutual affinity score according to an embodiment of the present invention, and FIG. 6 illustrates examples according to an embodiment of the present invention.

You can compute a weighted mutual affinity score:

A 10-level “connection chain” for illustration, starting from:
1 Guild Member (G₀), who is connected to 1 Vendor (V₁), who is connected to 1 Client (C₂), and then extend that chain up to the 10th level, alternating or mixing roles to simulate a real MyOpenGuild ecosystem.

Concept: One-String Chain From a Guild Member

We start with:
G₀(Guild Member)
   And build a linear chain of connections:

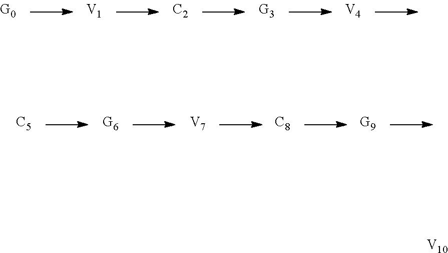

### Visual Representation (One-String Path):

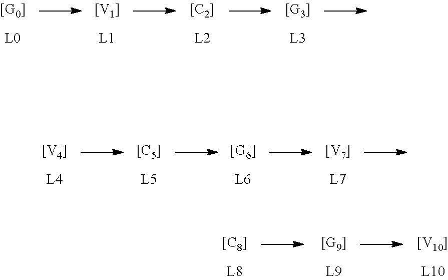

Each entity is connected only to the next in a linear fashion.

The illustrations of embodiments described herein are intended to provide a general understanding of the structure of various embodiments, and they are not intended to serve as a complete description of all the elements and features of apparatus and systems that might make use of the structures described herein.

Many other embodiments will be apparent to those of skill in the art upon reviewing the above description. Other embodiments may be utilized and derived therefrom, such that structural and logical substitutions and changes may be made without departing from the scope of this disclosure.

Figures are also merely representational and may not be drawn to scale. Similar numerals designate similar elements among the several figures. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown.

This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A computer-implemented method for operating a relationship-based network, comprising:
receiving a connection request from a user;
adding another user to the user's defined relationship-based network based on an indication of an acceptance by the other user;
building a linear chain of connections;
computing a weighted mutual affinity score;
displaying existing connections, dynamically updated new connections, and categories for a user's connections using tags or labels;
displaying full profiles for one or more first-degree connections directly connected users sent connection requests to which have been have accepted;
display partial profile information for second-degree connections which are the clients or vendors of the user's first degree connections; and
displaying limited profile information for third-degree connections which are the connections of the user's second-degree connections.

2. The method of claim 1, further comprising intentionally limiting direct visibility and interaction of 4th, 5th, 6th, and higher degree connections.

3. The method of claim 1, further comprising combining 3rd plus connections combined into one group 3rd plus.

4. A computer-implemented method for operating a relationship-based business networking platform, the method comprising:
receiving, by a computing system, a connection request from a first user;
determining whether a second user accepts the connection request;
upon acceptance, adding the second user to the first user's relationship-based network as a first-degree connection;
categorizing the first user's network into degrees of connection comprising:
first-degree connections, including users directly connected to the first user;
second-degree connections, including users connected to the first user's first-degree connections, wherein the second-degree connections are categorized as clients or vendors of the first-degree connections;
third-degree connections, including users connected to the second-degree connections;
third-degree-plus connections including users connected to the third-degree connections
connection with free of charge level displaying:
full profile information for first-degree connections;
partial profile information for second-degree connections;
limited profile information for third-degree connections;
tagging or labeling connections with categories selected by the user;
dynamically updating the displayed network connections upon changes in network relationships;
and generating a weighted mutual affinity score between the first user and other users based on shared connection depth, roles, and verification status.

5. The method of claim 4, wherein the mutual affinity score is calculated using a weighted graph algorithm based on the number and strength of shared clients, vendors, and intermediary connections.

6. The method of claim 4, further comprising restricting visibility and access to users beyond third-degree connections, including fourth-degree and higher, to reduce user interface complexity.

7. The method of claim 4, wherein the user may define relationship roles for each connection, including but not limited to: client, vendor, affiliate, or partner.

8. The method of claim 4, further comprising a verification process for validating business entities prior to allowing them to establish or accept a connection, the verification comprising email domain confirmation, business registration data, or third-party authentication.

9. The method of claim 4, wherein different levels of user membership define the visibility of connection information, with higher-tier membership enabling access to additional degrees of connection data and affinity analytics.

10. The method of claim 4, wherein users are permitted to request introductions to second-degree or third-degree users through mutual first-degree connections.

11. The method of claim 4, further comprising providing recommendations for new connections based on the user's existing client and vendor relationships, industry category, and engagement behavior on the platform.
